(19) United States
(12) Patent Application Publication
(10) Pub. No.: US 2019/0059235 A1
(43) Pub. Date: Feb. 28, 2019

(54) Bokashi Mushroom Growth Substrate

(71) Applicant: Innovative Organics Patent Holdco, LLC, Loveland, CO (US)

(72) Inventor: Victor H. Restrepo, Denver, CO (US)

(21) Appl. No.: 15/688,856

(22) Filed: Aug. 28, 2017

(51) Int. Cl. A01G 1/04; C05F 9/04; C05F 11/08

(52) U.S. Cl. CPC A01G 1/04; A23L 31/00; C05F 11/08; C05F 9/04

(57) ABSTRACT

Substrates for mushroom growth comprise bokashi growth mediums. Bokashi growth mediums comprise acid and chitin sources. Bokashi growth mediums may further comprise an inoculant. Exemplary inoculants provided include a bokashi tea. Methods of providing a substrate for mushroom growth. Methods of growing a mushroom.

### FIELD OF THE INVENTION

The disclosure relates generally to the field of bokashi products for mushroom growth and methods.

### BACKGROUND

Mushroom cultivation requires complex substrates rich in nutrients. Traditionally, substrates must be carefully controlled or sterilized to ensure the proliferation of the desired mushroom strain. Sterilization methods may include physical and chemical processing of a substrate, which typically is a soil containing compost or another nutrient source. Substrates are changed often to prevent competitive fungi and other growth from reducing or eliminating the growth of desirable fungi and mushrooms. Additionally, additives may be used to improve desirable mushroom growth on the substrate. Typical mushroom yields are suboptimal, and a significant amount of waste may occur. Once harvested, fungi have a very short shelf life, driving waste, high cost, and low availability of commercially desirable fungi, such as those with culinary uses.

The invention addresses one or more of the aspects discussed above.

### SUMMARY

In some aspects, a substrate for mushroom growth is provided. The substrate may comprise a bokashi growth medium. A bokashi growth medium may comprise an acid source, which may be a sawdust. In some embodiments, the bokashi growth medium comprises a pine sawdust.

A bokashi growth medium may comprise a chitin source, and in some embodiments may comprise coffee hulls.

A bokashi growth medium may comprise a fibrous additive, which may be cardboard.

A bokashi growth medium may further comprise an inoculant. In some embodiments, the inoculant comprises a bokashi tea.

In some aspects, methods of providing a substrate for mushroom growth are provided. In an exemplary method, a growth medium is provided and processed. A growth medium may be inoculated with microbes. The inoculated growth medium may be fermented under anaerobic conditions to provide a bokashi growth medium.

In some aspects of the method, the growth medium comprises an acid source, which may be a pine or pine sawdust. In some aspects, the substrate comprises a chitin source, which may comprise coffee hulls. In aspects, the growth medium comprises a fibrous additive, which may be a cardboard.

In some aspects, the method comprises adding water.

Methods of growing a mushroom are provided. In aspects, a method of growing a mushroom comprises inoculating a substrate comprising a bokashi growth medium with a mushroom spore.

In aspects, a mushroom grown from a substrate comprising a bokashi growth medium is provided.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings:

FIG. 1 is a flowchart illustration of an embodiment showing a method for generating mushroom growth substrate.

### DETAILED DESCRIPTION

The Detailed Description is provided to illustrate aspects of the invention. It is anticipated that additional compositions and methods are enabled by the detailed description, the inclusion of which are hereby contemplated and included. In no case shall the explicit contents herein be construed to limit the invention to the aspects and embodiments discussed below.

The following definitions are provided for use herein:

“Mushroom(s)” as used herein refer to one or more fungal species. Fungal species share a number of traits and nutrient requirements that allow them to benefit from the invention. In some embodiments, mushrooms may be edible, for example those widely cultivated for culinary use. Culinary mushrooms are often selected for traits such as flavor, size, and overall appearance. Other desirable factors for edible and culinary mushrooms are growth characteristics, safety, and shelf stability. Use of the invention in any mushroom is contemplated.

“Substrate” as used herein refers to a composition capable of housing or growing a fungus or mushroom. Fungi grow on the “surface” of a particulate substrate, however note that due to the small size of fungi and the nature of their mycelium, the “surface” of any particle may be within a larger volume of particles. For example, the term “substrate” as used herein includes any volumetric configuration of the compositions provided herein, including but not limited to loose volumes or contained shapes, such as a barrel. In a particular embodiment, substrates are provided in a form desirable to a final consumer, such as in a bag or box, similar to the form factors that traditional soils are provided in.

“Bokashi growth medium” as used herein refers to a product comprising fermented organic matter created under generally acidic, anaerobic conditions, or “bokashi fermentation.” Bokashi fermentation differs significantly from normal fermentation and decomposition, and is similar to a pickling process. When performed properly, acidic anaerobic conditions allow specific microorganisms to flourish. Typical microorganisms include strains of lactobacilli, yeast, and phototropic microbes. Because bokashi conditions are specifically tailored to desirable microorganisms and unsuitable for others, a desirable microorganism environment may be maintained and promoted. This microorganism environment breaks down organic materials into a nutrient-rich composition with high nutrient bioavailability. Further, microorganisms flourish and then die at various times during Bokashi fermentation, and the final product or bokashi growth medium is substantially sterile.

“Inoculant” as used herein refers to an agricultural amendment comprising beneficial growth aids, nutrients, microorganisms, or other factors. Inoculants may be applied to a substrate or soil to increase the presence of factors that are associated with improved plant health, disease resistance, or other desirable traits. An exemplary inoculant comprises microorganisms such as lactobacillus and other favorable bokashi microorganisms and factors, and may be added prior to bokashi fermentation. In some aspects the inoculant is itself a product of bokashi fermentation, such as the bokashi “tea” or liquid that is released during bokashi fermentation. Bokashi tea may be produced before the natural endpoint of the bokashi process, retaining beneficial microbes and compounds that may no longer be present once bokashi fermentation is completed. In some cases, inoculants may be added after bokashi fermentation to reintroduce microorganisms or promote plant health and nutrition. Note that mushroom spores are also introduced to substrates via a process of inoculation, however a distinction is drawn between inoculants used for bokashi fermentation and spore inoculation for mushroom growth.

Substrates for Mushroom Growth.

In aspects of the invention, a substrate for mushroom growth is provided. Substrates may comprise a bokashi growth medium. In some embodiments, use of a bokashi growth medium may provide a number of improvements for mushroom growth. For example, the bokashi process increases overall nutrient availability by thoroughly breaking down organic matter. Thus, the bioavailability and overall nutrient content available for mushroom growth is much higher. This is particularly relevant for mushrooms, as they rely on decomposing food sources. The bokashi growth medium may more closely resemble the products of decomposition than a traditional growth substrate, such as a treated soil.

The bokashi growth medium may be of any suitable composition or origin. In fact, it is possible to use a variety of organic sources, such as various organic food or agricultural wastes. Due to the specific conditions of bokashi fermentation, presence of competitive microbes, and overall high breakdown of organic matter, substrates created through bokashi fermentation often resemble one another for most purposes. For example, organic sources such as banana peels and coffee hulls can both be successfully used to generate a general soil amendment or other broadly useful composition.

In some embodiments it is desirable to ferment specific organic products to deliver nutrients and an environment specifically beneficial to mushroom growth. In embodiments, the bokashi growth medium comprises an acid source. Acidic environments are often preferred for mushroom growth, and mushrooms metabolize a number of acidic compounds. In one embodiment, pine wood, such as that in sawdust form, is used. Pine comprises acids, terpines and other compounds that provide additional nutrition specific to mushroom growth and proliferation. Additionally, pine is widely available, and even waste pine such as beetle killed pine may be used.

In some embodiments, the bokashi growth medium comprises a source of chitin. Chitin is used extensively by mushrooms to grow their cell walls and overall structure. Chitin may also inhibit the growth of undesirable bacteria and other microorganisms that can compete with desirable fungi. In some embodiments, coffee hulls are used as a source of chitin. Coffee hulls have a high amount of chitin, however it is typically not bioavailable for immediate use by mushrooms. In aspects of the invention, the bokashi fermentation breaks down coffee hulls into bioavailable chitin suitable for mushroom growth.

In aspects of the invention, the combination of high bioavailable chitin and acidic compounds specific to mushroom growth produce a favorable substrate for mushroom growth an proliferation. In some aspects, bokashi fermentation of a chitin source and an acid source increase the speed of the spread of the mushroom mycelium, and in some aspects increase the overall growth rate of mushrooms.

In some aspects, the substrate further comprises a fibrous additive, which may be a cardboard. Fibrous additives may provide additional spaces for mushroom mycelia to grow and proliferate. Additionally, chitinases within a bokashi growth medium break down waxy substances commonly used to coat and produce cardboards, enhancing the degradation of cardboard into a carbon source for growth.

In aspects, a substrate comprises an inoculant. Inoculants may be added to the products of bokashi fermentation to improve the substrate's nutrition, microbial environment, or other characteristics. In some embodiments, an inoculant comprises bokashi tea. Bokashi tea is the liquid produced during bokashi fermentation, which is exceptionally nutrient-rich and contains high concentrations of bioavailable compounds for plant growth and health. Inclusion of bokashi tea may increase the concentration of these factors, as well as reduce the proliferation of undesirable fungi and competing organisms. In other embodiments, inoculants comprise plant health agents, nutrients, fungicides, nematocides, and the like.

Methods of Providing a Substrate for Mushroom Growth.

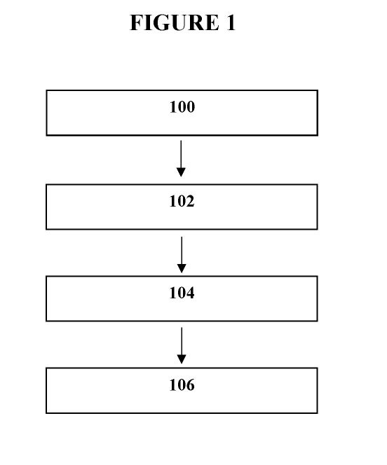

In some aspects, as shown in FIG. 1, a method of providing a substrate for mushroom growth comprises providing a growth medium 100, processing a growth medium 102, inoculating the processed growth medium with microbes 104, and fermenting the inoculated material under acidic anaerobic conditions to provide a bokashi growth medium 106.

Growth media are provided 100 according to the selection criteria and discussion found above. Growth media may be processed 102 for use in a bokashi process. Processing may include physical or chemical steps, e.g. mulching, chopping, heating, etc. Media may be processed to allow mixing or agitation, for example in large mixing apparatus suitable for bokashi preparation. In some embodiments, mulches, sawdusts, and the like may be prepared for fermentation. In embodiments, sawdust is used. In other embodiments, coffee hulls are processed to a fine size to improve mixability and promote fermentation. In some embodiments, other additives may be included, and in some embodiments a fibrous additive is included. In embodiments, the fibrous additive is a cardboard.

In embodiments, the method proceeds to inoculate a processed growth medium 104 with an inoculant, which may comprise microbes as discussed elsewhere. Inoculation may be done in any suitable form, such as solid or liquid, and may comprise further agitation or mixing of the growth media. In some embodiments, inoculation provides essential microbes and other compounds to allow bokashi fermentation to begin. In other embodiments, inoculation aids in the development of bokashi fermentation. In some embodiments, an inoculant is not required to develop a suitable bokashi environment. In some embodiments, growth media and inoculants are combined and processed in a single step. In other embodiments, multiple or separate steps may be used before combining processed growth media with an inoculant.

In some embodiments, additional water or other liquid is added at any step 102, 104, or 106. Liquid may be aded to enhance mixing, handling, or fermentation aspects.

In embodiments, the method proceeds to ferment the inoculated material under acidic anaerobic conditions 106. An acidic anaerobic condition is typically required for bokashi fermentation. Fermentation is typically carried out at ambient temperature, and in embodiments is completed in less than seven days, less than ten days, or less than fourteen days. The speed of fermentation may be determined or controlled by the ambient temperature, and in some aspects the ambient temperature is kept at approximately 72 degrees Fahrenheit. In other embodiments, ambient temperature is elevated above 72 degrees Fahrenheit to increase the speed of fermentation. In embodiments, fermentation is carried out in dark and sealed containers to prevent oxidation and other degradation. After or during fermentation, excess liquid or “tea” may be removed from the mixture. The final dry or nearly-dry product is a bokashi growth medium.

Mushroom growth

In aspects, a method of growing a mushroom is provided. A substrate comprising a bokashi growth medium may be inoculated with a mushroom spore or spore-containing composition. Spore compositions may be of any type. In aspects, spore-containing inoculant compositions may be commercially sourced, or may be derived from spore prints or preserved mushroom matter. Inoculation may be performed with or without mixing, and in some embodiments the substrate is mixed with the inoculant. General mushroom growth methods are known in the art.

Inoculated substrate is placed into a suitable mushroom growth vessel, as found in the art. Mushroom growth vessels are allowed to rest at a suitable mushroom growth temperature, such as ambient or room temperature. In some aspects, the temperature is above 72 degrees Fahrenheit.

In some aspects, mushroom growth remains at a pH of under 6.4, preventing or reducing methane production and preventing or reducing the production of methylene gas. In some aspects, pH is less than 6.0, and in some aspects is less than 5.6. In some aspects, reduction of methylene gas improves mushroom shelf life. In embodiments, harvested mushroom shelf life is improved to at least 14 days, and in some embodiments harvested mushroom shelf life is at least 20 days. In aspects, harvested mushroom shelf life is more than 20 days.

In aspects, growth may be continued until less desirable fungi begin to emerge from the vessel. In aspects, less desirable fungi take longer to emerge from the vessel than using traditional mushroom growth substrates.

In aspects, the substrate may be reclaimed and reused for another bokashi cycle after mushroom production is complete.

In aspects, a mushroom is provided. Mushrooms may be any grown using the substrates and methods identified above, and may be of any suitable type or use. In some aspects, the mushroom is an edible mushroom for culinary use or human consumption.

The preceding description is presented for purposes of illustration and description, and does not limit the scope of the invention to the disclosures, examples, and embodiments provided therein. On the contrary, a number of modifications and variations are possible based on the above teachings, and alternative embodiments are included to the full scope allowable by the prior art.

What is claimed is:

1. A substrate for mushroom growth comprising a bokashi growth medium.

2. The substrate of claim 1 wherein the bokashi growth medium comprises an acid source.

3. The substrate of claim 2 wherein the bokashi growth medium comprises a pine sawdust.

4. The substrate of claim 1 wherein the bokashi growth medium comprises a chitin source.

5. The substrate of claim 4 wherein the bokashi growth medium comprises coffee hulls.

6. The substrate of claim 1 further comprising a fibrous additive.

7. The substrate of claim 6 wherein the fibrous additive is cardboard.

8. The substrate of claim 1 further comprising an inoculant.

9. The substrate of claim 8 wherein the inoculant is a bokashi tea.

10. A method of providing a substrate for mushroom growth comprising:
Providing a growth medium;
Processing the growth medium;
Inoculating the processed growth medium with microbes; and
Fermenting the inoculated material under acidic anaerobic conditions to provide a bokashi growth medium.

11. The method of claim 10 wherein the substrate comprises an acid source.

12. The method of claim 11 wherein the substrate comprises a pine sawdust.

13. The method of claim 10 wherein the substrate comprises a chitin source.

14. The method of claim 13 wherein the substrate comprises coffee hulls.

15. The method of claim 10 further comprising adding a fibrous additive.

16. The method of claim 15 wherein the fibrous additive is cardboard.

17. The method of claim 10 wherein the inoculant comprises a bokashi tea.

18. The method of claim 10 further comprising adding water.

19. A method of growing a mushroom, comprising inoculating a substrate comprising a bokashi growth medium with a mushroom spore.

20. A mushroom grown by any of the methods of claims 11-19.
